(19) United States
(12) Patent Application Publication
(10) Pub. No.: US 2025/0182256 A1
(43) Pub. Date: Jun. 5, 2025

(54) ITEM RETRIEVAL USING GENERATIVE INPAINTING

(71) Applicant: Adobe Inc., San Jose, CA (US)

(72) Inventors: Michele SAAD, Austin, TX (US); Irgelkha Mejia, River Edge, NJ (US)

(21) Appl. No.: 18/528,352

(22) Filed: Dec. 4, 2023

(51) Int. Cl. G06T 5/00; G06F 16/432

(52) U.S. Cl. CPC G06T 5/77; G06F 16/434

(57) ABSTRACT

Aspects of the technology described herein relate to performing item retrieval using generative inpainting. In accordance with some aspects, an image having one or more objects is accessed. Responsive to user input, a mask is applied to the image to provide a masked image, where the mask overlays at least a portion of a first object from the one or more objects. A generative model generates an inpainted image by inpainting the mask of the masked image. One or more search results are identified using the inpainted image and are provided for presentation.

### BACKGROUND

The amount of information and content available on the Internet and/or stored on devices continues to grow exponentially. Given the vast amount of information, search technologies have become integral to locating relevant information. For instance, search engines facilitate quickly finding items in electronic databases, such as, for instance, databases of items available on e-commerce systems. Search engines receive search queries and provide search results for items that are responsive to the search queries. For a given search query, a search engine can process the search query, user data, contextual data, and/or other inputs to identify the most relevant items for the particular search. Search results for identified items can be presented on a user device in several different forms, for instance, on a search results user interface.

### SUMMARY

Some aspects of the present technology relate to, among other things, using generative inpainting to facilitate item retrieval. In accordance with some aspects, a search system enables a user to select an input image for initiating a search and to draw a mask over at least a portion of an object in the input image. A masked image in which the mask overlays the input image is provided as input to a generative model. Based on the masked image, the generative model generates an inpainted image by inpainting the mask. In some aspects, additional information is used to inform the generative inpainting. For instance, attributes of the masked image (e.g., object types and appearances of objects in the input image) and/or additional user input (e.g., textual input or color input) are used in some instances to instruct the generative model on how to inpaint the mask.

A query is generated based on the inpainted image and used to query an item data store to identify items to provide as search results. The query can be an image query (e.g., using the inpainted image as a query image), a text-based query (e.g., by analyzing the inpainted image to generate attributes that are used to form a text query), or a multi-modal query combining the inpainted image with textual information.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing an example process for using generative inpainting for item retrieval in accordance with some implementations of the present disclosure;

FIG. 3 is a block diagram showing another example process for using generative inpainting for item retrieval in accordance with some implementations of the present disclosure;

FIG. 4 is a diagram illustrating an example user interface for submitting an input image for search in accordance with some implementations of the present disclosure;

FIGS. 5A-5C are diagrams illustrating example user interfaces for masking an image and providing other user inputs for generative inpainting in accordance with some implementations of the present disclosure;

FIGS. 6A-6B are diagrams illustrating example user interfaces for presenting search results identified using generative inpainting in accordance with some implementations of the present disclosure;

FIG. 7 is a flow diagram showing an overall method for using generative inpainting for search in accordance with some implementations of the present disclosure;

FIG. 8 is a flow diagram showing a method for generating an inpainted image for search in accordance with some implementations of the present disclosure; and

FIG. 9 is a flow diagram showing a method for using an inpainted image for search in accordance with some implementations of the present disclosure; and

FIG. 10 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, an “input image” refers to an image selected by a user and used to initiate a search for items using aspects of the technology described herein. An input image can include one or more objects. Each “object” is a physical item that is visually depicted in the input image. For example, an input image could comprise an image of a person wearing a shirt, pants, and a pair of shoes. In this example, the shirt, pants, and the pair of shoes are each an object that is visually depicted in the image.

As used herein, a “mask” refers to a binary or grayscale image used to specify areas (e.g., pixels) of the input image that will be the subject of inpainting. In accordance with some aspects described herein, a user provides input in conjunction with the input image to draw the mask.

A “masked image” is used herein to refer to an image in which a mask has been applied to an input image.

A “underlying object” is an object in an input image that is covered by a mask. For instance, in an example in which the input image comprises an image of a person wearing a shirt, pants, and a pair of shoes, and where the user has drawn a mask over the pants, the pants comprise the underlying object.

A “generative model” is used herein in the context of image content generation to refer to a type of machine learning model that takes a masked image (and, in some cases, other information) as input and generates an output image, referred to herein as an “inpainted image”. The generative model generates the inpainted image by determining pixel values for pixels of the mask. By inpainting the mask, the generative model provides an “inpainted object” in the inpainted image. In some cases, the generative model also generates pixel values for pixels corresponding to portions of an underlying object that is outside of the mask, referred to herein as a “delta region.” For instance, in an example in which the input image is an image of person wearing pants and the a mask overlays the pants with a portion of the pant legs extending outside of the mask, the portion of the pant legs extending outside of the mask would be considered a delta region. In that example, the generative model can determine pixel values for the delta region (e.g., with pixel values to show the person's legs in the delta region). The generative model can comprise one or more neural networks, autoencoders, or generative adversarial networks (GANs). The generative model can be trained on image dataset to be capable of synthesizing pixel values in the mask and/or delta regions of masked images.

As used herein, a “masked image attribute” comprises an attribute determined by analyzing a masked image. A masked image attribute could comprise an attribute of an object in the underlying input image over which a mask was laid to provide the masked image. This could include, for instance, an attribute identifying an object type or an appearance (e.g., color, pattern, material, etc.) of the object. A masked image attribute could also identify one of the objects in the underlying input image as an underlying object on which a mask was overlaid. A masked image attribute could further comprise an attribute of the mask, such as an object type.

The term “inpainted image attribute” is used herein to refer to an attribute determined by analyzing an inpainted image. An inpainted image attribute could comprise an attribute of an object in the inpainted image, including the inpainted object and other objects from the input image. This could include, for instance, an attribute identifying an object type or an appearance (e.g., color, pattern, material, etc.) of the object.

### Overview

While search systems are useful tools for locating items, shortcomings in existing search technologies often result in the consumption of an unnecessary quantity of computing resources (e.g., I/O costs, network packet generation costs, throughput, memory consumption, etc.). For instance, current search systems often fall short in allowing users to efficiently find items of interest. This could be a result of limited query understanding by the search engine. Search systems typically operate on keyword-based queries and may not fully understand some queries, such as complicated natural language queries submitted by some users. While some search systems provide for visual search in which an image-based query is used to search for items, this requires users to identify images that adequately capture what the user is seeking. Absent such images, users are left to perform text-based searches that often don't adequately capture visual aspects of items users are seeking.

As a result of shortcomings in existing search technologies, users often have to submit multiple queries before finding desired items. For example, a user may issue a first query to a search engine that returns a set of search results for a given item. The user may browse the search results and select certain search results to access the corresponding items. Selection of items causes retrieval of the items from various content sources. Additionally, in some cases, applications supporting those items are launched in order to render the items. In the context of recommendation, when recommended items are insufficient, users may select certain items to view the item pages and discover the items are not what the user is seeking. This often results in the users turning to query-based searching, which can involve issuing numerous queries in an attempt to identify relevant items as discussed above.

These repetitive inputs result in increased computing resource consumption, among other things. For instance, repetitive user queries result in packet generation costs that adversely affect computer network communications. Each time a user issues a query, the contents or payload of the query is typically supplemented with header information or other metadata within a packet in TCP/IP and other protocol networks. Accordingly, when this functionality is multiplied by all the inputs needed to obtain the desired data, there are throughput and latency costs by repetitively generating this metadata and sending it over a computer network. In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if users repetitively issue queries, it is expensive because processing queries consumes a lot of computing resources. For example, for some search engines, a query execution plan may need to be calculated each time a query is issued, which requires a search system to find the least expensive query execution plan to fully execute the query. This decreases throughput and increases network latency, and can waste valuable time.

Aspects of the technology described herein improve the functioning of the computer itself in light of these shortcomings in existing search technologies by providing a solution that enables a search system to leverage generative models to generate inpainted images that are used for searching items to return as search results.

The search system enables a user to select an input image with one or more objects and apply a mask overlaying at least a portion of one of the objects to generate a masked image. For instance, a user could have a picture of a person wearing an outfit that includes a shirt, pants, and a pair of shoes and wish to search for alternatives to the pants to complete the outfit. In this example, the user uploads the image to the search system and draws a mask overlaying the pants with a different silhouette, such as a silhouette for wide leg culottes.

The masked image is provided as input to a generative model, which generates an inpainted image by inpainting the mask. In some aspects, the masked image is analyzed to determine attributes that facilitate how the generative model inpaints the mask. For instance, object detection and recognition could be performed to identify the object type and appearance attributes (e.g., color, pattern, material, etc.) of objects in the masked image, including the underlying object over which the mask was laid. The silhouette of the mask could also be analyzed to determine attributes, such as an object type. In further aspects, additional user input, such as text input or color information, is used to inform the generative model. As an example, a user could enter text, such as “green wide leg culottes linen” and a prompt could be generated that instructs the generative model to inpaint the mask to provide the appearance of wide leg culottes that are green and made of linen. In this way, the inpainted image provided by the generative model essentially replaces the underlying object (e.g., pants) from the input image over which the mask has been placed with an inpainted object that matches the user's search intent.

A query is generated based on the inpainted image and used to search an item data store to identify relevant items, and search results are provided based on the identified items. In some aspects, a visual search is performed using the inpainted image as a query image. In some aspects, a text-based search is performed by analyzing the inpainted image to determine textual attributes that are used to generate a text-based query. In further aspects, a multi-modal search is performed in which a query is formed using both the inpainted image and text (e.g., attributes determined from analysis of the inpainted image). For instance, a multi-modal embedding could be generated from the inpainted image and attributes determined from analysis of the inpainted image.

Aspects of the technology described herein provide a number of improvements over existing search technologies. For instance, computing resource consumption is improved relative to existing technologies. In particular, allowing a user to draw a mask over an image with objects and generate an inpainted image by inpainting the mask, the search system allows for generation of queries that more accurately capture what the user is seeking. This allows the search system to more effectively identify relevant items as search results. This eliminates (or at least reduces) the repetitive user queries, search result selections, and rendering of items because users can more readily identify relevant items without the need to continuously input various search queries to access search results and/or continuously make item selections to obtain further information around presented items. Accordingly, aspects of the technology described herein decrease computing resource consumption, such as packet generation costs. For instance, a user query (e.g., an HTTP request), would only need to traverse a computer network once (or fewer times relative to existing technologies). Specifically, the contents or payload of the user query is supplemented with header information or other metadata within a packet in TCP/IP and other protocol networks once for the initial user query. Such packet for a user query is only sent over the network once or fewer times. Thus, there is no repetitive generation of metadata and continuous sending of packets over a computer network.

In like manner, aspects of the technology described herein improve storage device or disk I/O and query execution functionality, as they only need to go out to disk a single time (or fewer times relative to existing search technologies). As described above, the inadequacy of existing search technologies results in repetitive user queries, search result selections, and item renderings. This causes multiple traversals to disk. In contrast, aspects described herein reduce storage device I/O because the user provides only minimal inputs and so the computing system does not have to reach out to the storage device as often to perform a read or write operation. For example, the system can respond with search result items that satisfy user intent from a single user query (or few queries relative to existing technology). Accordingly, there is not as much wear on components, such as a read/write head, because disk I/O is substantially reduced.

Various configurations also improve query execution resource savings. Specifically, for example, the search system calculates a query execution plan on fewer queries relative to existing search technologies. This increases throughput and decreases network latency because aspects of the technology described herein do not have to repetitively calculate query execution plans because fewer user queries need to be executed, unlike existing search technologies.

### Example System for Item Retrieval Using Generative Inpainting

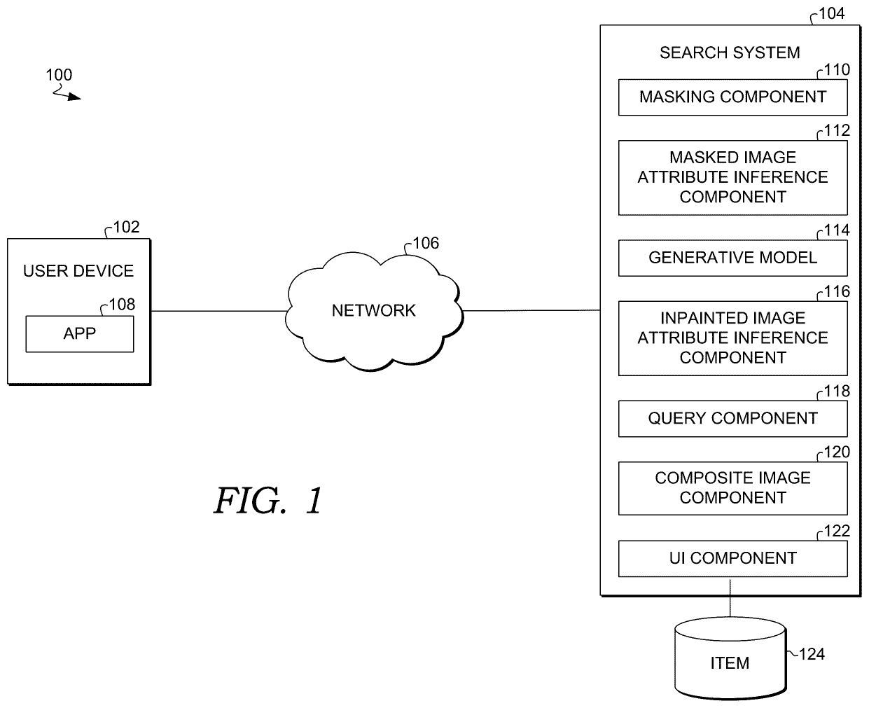

With reference now to the drawings, FIG. 1 is a block diagram illustrating an exemplary system 100 for using generative inpainting for item retrieval in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

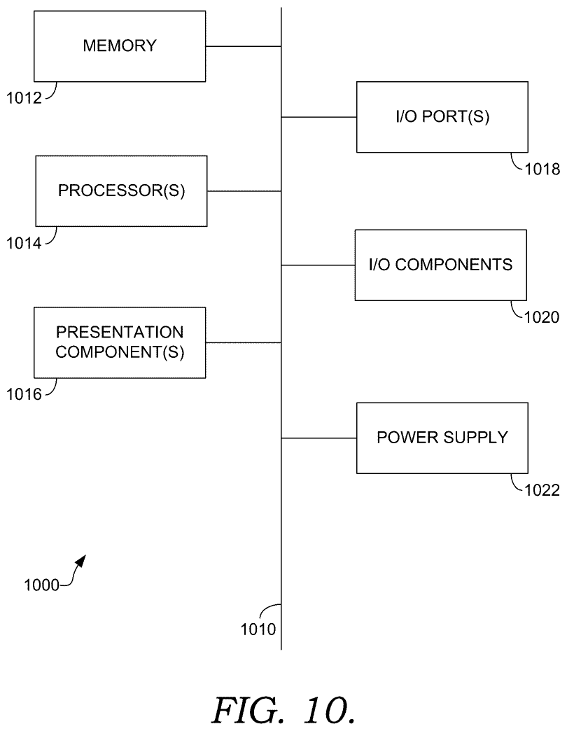

The system 100 is an example of a suitable architecture for implementing certain aspects of the present disclosure. Among other components not shown, the system 100 includes a user device 102 and a search system 104. Each of the user device 102 and search system 104 shown in FIG. 1 can comprise one or more computer devices, such as the computing device 1000 of FIG. 10, discussed below. As shown in FIG. 1, the user device 102 and the search system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and servers can be employed within the system 100 within the scope of the present technology. Each can comprise a single device or multiple devices cooperating in a distributed environment. For instance, the search system 104 could be provided by multiple server devices collectively providing the functionality of the search system 104 as described herein. Additionally, other components not shown can also be included within the network environment.

The user device 102 can be a client device on the client-side of operating environment 100, while the search system 104 can be on the server-side of operating environment 100. The search system 104 can comprise server-side software designed to work in conjunction with client-side software on the user device 102 so as to implement any combination of the features and functionalities discussed in the present disclosure. For instance, the user device 102 can include an application 108 for interacting with the search system 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the search system 104 remain as separate entities. While the operating environment 100 illustrates a configuration in a networked environment with a separate user device and search/recommendation system, it should be understood that other configurations can be employed in which components are combined. For instance, in some configurations, a user device can provide search capabilities described in conjunction with the search system.

The user device 102 can comprise any type of computing device capable of use by a user. For example, in one aspect, the user device can be the type of computing device 1000 described in relation to FIG. 10 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user can be associated with the user device 102 and can interact with the search system 104 via the user device 102.

In accordance with some aspects, the search system 104 can be part of a listing platform. Examples of listing platforms include e-commerce platforms, in which listed products or services are available for purchase by a user of a client device upon navigation to the platforms. Other examples of listing platforms include rental platforms listing various items for rent (e.g., equipment, tools, real estate, vehicles, contract employees) and media platforms listing digital content items (e.g., digital content for streaming/download).

The functionality of a listing platform includes provision of interfaces enabling surfacing of item listings for items to users of the listing platform. Item listings for items available for sale/rent/consumption via the listing platform are stored by the item data store 124. Each item listing can include a description relating to the item comprising one or more of a price in a currency, reviews, images of the item, shipment options, a rating, a condition of the item, a size of the item, a color of the item, etc. In aspects, the item is associated with one or more categories including meta-categories and leaf categories. For example, the meta-categories are each divisible into subcategories (or branch categories), whereas leaf categories are not divisible.

At a high level, the search system 104 performs item retrieval using generative inpainting. Given an image selected by a user associated with a user device, such as the user device 102, and a mask applied to the image by the user, the search system 104 inpaints the mask to provide an inpainted image and employs the inpainted image to identify items to return as search results to the user device. As shown in FIG. 1, the search system 104 includes a making component 110, a masked image attribute inference component 112, a generative model 114, an inpainted image attribute inference component 116, a query component 118, a composite image component 120, and a user interface component 122. The components of the search system 104 can be in addition to other components that provide further additional functions beyond the features described herein. The search system 104 can be implemented using one or more server devices, one or more platforms with corresponding application programming interfaces, cloud infrastructure, and the like. While the search system 104 is shown separate from the user device 102 in the configuration of FIG. 1, it should be understood that in other configurations, some or all of the functions of the search system 104 can be provided on the user device 102.

In one aspect, the functions performed by components of the search system 104 are associated with one or more personal assistant applications, services, or routines. In particular, such applications, services, or routines can operate on one or more user devices, servers, can be distributed across one or more user devices and servers, or be implemented in the cloud. Moreover, in some aspects, these components of the search system 104 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

When an input image is selected by a user for initiating a search, the masking component 110 of the search system 110 facilitates applying a mask to the input image based on user input. For instance, a user associated with the user device 102 could employ the application 108 to interact with the search system 104 and select an input image for performing a search. The input image can be selected by the user in any of a number of different ways. For instance, the user could employ a camera on the user device 102 to take a photo and provide the photo to the search system 104. As another example, the user could select an image stored on the user device 102 or a network location and provide the image to the search system 104. As yet another example, the user could select an image from search results provided by the search system 104.

The search system 104 provides a user interface to the user device 102 that displays the input image and provides one or more tools for applying a mask to the input image. For instance, the user interface could include a drawing tool that allows the user to employ a cursor or other input mechanism to draw a mask over a portion of the input image. The masking component 110 provides a masked image based on the mask drawn by the user. The masked image includes the input image with a mask overlaying a portion of the input image.

The masked image attribute inference component 112 analyzes the masked image to determine one or more masked image attributes that can be used to facilitate inpainting the mask by the generative model 114, as will be discussed in further detail below, and/or forming a query by the query component 118, as will be discussed in further detail below. The masked image attribute inference component 112 can employ any of a variety of computer vision techniques to analyze the masked image and determine attributes. In some aspects, the masked image attribute inference component 112 performs object detection and recognition to identify and classify objects in the input image. Object detection is a process of locating objects within the masked image. It can include drawing bounding boxes around objects. The primary goal is to determine where the objects are in the image. Object detection can be performed using a machine learning model employing any of a variety of object detection algorithms, such as, for instance, Faster R-CNN, YOLO (You Only Look Once), and SSD (Single Shot MultiBox Detector). Object recognition is a process of identifying what an object is based on the features or characteristics extracted from the object. This can be done using machine learning models, such as Convolutional Neural Networks (CNNs), to classify objects into predefined categories or classes. The output of the object recognition is an object type for each detected object.

Object detection and recognition can be performed to determine object types for objects in the input image. For instance, suppose a user uploads an image of a person wearing an outfit that includes a shirt, pants, and a pair of shoes. In that case, the masked image attribute inference component can identify each of those as separate objects—i.e., a shirt object, pants object, and shoes object. In some cases, the person can also be identified as an object.

The masked image attribute inference component 112 can also determine various attributes associated with the appearance of the objects from the input image. This could include, for instance, the colors and patterns of the objects. In some instances, material detection techniques are employed to determine a material of the objects (e.g., in the case of clothing). Material detection in computer vision refers to the task of identifying and classifying the materials or substances that make up the objects in an image. It can be performed, for instance, using a machine learning model, such as Convolutional Neural Networks (CNNs) and support vector machines, trained on labeled datasets to predict materials based on the feature information extracted from images.

The masked image attribute inference component 112 can also determine an object type for the mask. This can be based on a variety of different factors. For instance, the object type for the mask can be determined based on the underlying object in the input image on which the mask is overlaid. For instance, continuing the example in which the input image shows a person wearing a shirt, pants, and pair of shoes, suppose the user drew the mask over the pants in the input image. Based on the mask overlaying the pants in the input image, the masked image attribute inference component 112 can identify an object type of pants for the mask. In some cases, the object type for the mask can be determined at a higher level of abstraction or a lower level of abstraction. As an example of a higher level of abstraction, instead of associating an object type of pants with the mask, a broader object type of bottoms could be assigned.

In some aspects, the masked image attribute inference component 112 determines the object type for the mask based at least in part on the silhouette of the mask. For instance, object recognition techniques could be employed that determine an object type based on the shape of the mask. As an example to illustrate, the silhouette of the mask could include wide legs that are shorter than the underlying pants in the input image. Based on this silhouette, the masked image attribute inference component 112 could determine the object type of the mask to be wide leg culottes. In some aspects, the masked image attribute inference component 112 can further determine material attributes based on the silhouette of the mask. For instance, in the example of a mask of wide leg pants, the masked image attribute inference component 112 could determine some materials, such as linen, would be used to provide this shape, while other materials, such as leather, would not.

The generative model 114 inpaints the mask of the masked image to provide an inpainted image with an inpainted object. In particular, the generative model 114 selects pixel values (e.g., RGB values) for pixels of the mask to generate the inpainted image. In some instances, the generative model 114 generates a single inpainted image; while, in other instances, the generative model 114 generates multiple inpainted images, each with different inpainted objects. The generative model 114 takes, as input, the masked image provided by the masking component 110 and inpaints the mask to provide the inpainted image(s). The generative model 114 can also take, as input, one or more masked image attributes determined by the masked image attribute inference component 112. The one or more mask image attributes can serve as additional information that is processed by the generative model 114 when inpainting the mask.

The generative model 114 can further take, as input, additional user inputs that serve as still further information processed by the generative model when inpainting the mask to provide the inpainted object. In some aspects, the additional user input is text. This text input can be used to generate a prompt that is provided as input to the generative model 114. For instance, continuing the example above in which the user has drawn a mask over pants in an underlying image, the user could also provide the text: “green wide leg pant linen.” In this example, the masked image could be provided with a prompt that instructs the generative model 114 to inpaint the mask with wide leg pants that are green and made of linen.

Another type of additional user input that can be provided as input to the generative model 114 is color information selected from a variety of color options. For instance, a number of color harmony preferences could be provides as user-selectable options, such as monochromatic, triad, complementary, split complementary, compound, and shades color options. The selection of a color option, in conjunction with the colors of other objects in the masked image in some case, could be used by the generative model 114 to determine the color to inpaint the mask.

In further aspects, the additional user input could be a user selection or indication of one or more objects from the masked image. For instance, the user could provide text: “wide leg pants that match the shirt.” In this example, the generative model 114 is being instructed to inpaint the mask in a way such that the inpainted object provided by the inpainting matches the shirt in the underlying image. In still further aspects, the additional user input could be a user selection or indication of one or more objects from another image. For instance, a user could upload another image with a shirt and provide text: “wide leg pants that match the shirt in this other image.” In this example, the generative model 114 is being instructed to inpaint the mask in a way such that the inpainted object provided by the inpainting matches the shirt in the additional uploaded image.

The generative model 114 can comprise any type of machine learning model that can take a masked image, with or without additional inputs, and generate an inpainted image in which the mask is inpainted. In accordance with some aspects, the generative model 114 comprises a neural network. As used herein, a neural network comprises at least three operational layers, although a neural network can include many more than three layers (i.e., a deep neural network). The three layers can include an input layer, a hidden layer, and an output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, the generative model 114 is a pre-trained model that has not been fined-tuned. In other configurations, the generative model 114 is a model that is built and trained from scratch or a pre-trained model that has been fine-tuned. In such configurations, the generative model 114 can be trained or fine-tuned using training data and one or more loss functions. For instance, the training data can comprise pairs of masked images and ground truth images, and the generative model 114 is trained to fit the training data. During training, weights associated with each neuron can be updated. Originally, the generative model 114 can comprise random weight values or pre-trained weight values that are adjusted during training. In one aspect, the generative model 114 is trained using backpropagation. The backpropagation process comprises a forward pass, a loss function, a backward pass, and a weight update. This process is repeated using the training data. For instance, each iteration could include providing a masked image paired with a ground truth image as input to the model, generating an output by the model, comparing (e.g., computing a loss) the model output and the ground truth image, and updating the model based on the comparison. The goal is to update the weights of each neuron (or other model component) to cause the generative model to produce useful inpainted images. Once trained, the weight associated with a given neuron can remain fixed. The other data passing between neurons can change in response to a given input. Retraining the network with additional training data can update one or more weights in one or more neurons.

In some aspects, the generative model 114 can also modify pixel values for pixels outside of the mask. This can be, for instance, to remove one or more portions of the underlying object that extend outside of the mask. In particular, the area of the underlying object outside of the mask can be determined as a delta region by comparing pixels of the underlying object to pixels of the mask. Based on identification of the delta region, the generative model can determine pixel values for the pixels in the delta region based on analysis of the masked image to generate an inpainted image in which the underlying object in the delta region has been removed. For instance, in the example in which a mask has been overlaid on pants where the pant legs extend below the mask, the pixels corresponding to the portions of the pant legs outside of the mask are determined as the delta region. The generative model 114 generates pixel values for those pixels to remove the pant legs, for instance, by changing pixel values to generate an appearance of legs of the person wearing the pants.

While FIG. 1 shows a configuration in which the generative model 114 is included as part of the search system 104, it should be understood that other configurations can be employed in which a generative model is separate from the search system 104. For instance, a generative model could be provided by a separate system, and the search system 104 could employ an API to provide input (e.g., masked image, masked image attributes, and/or additional user input) to the generative model and, in response, receive inpainted images generated by the generative model.

In some instances, the one or more inpainted images generated by the generative model 114 are presented to the user prior to performing a search using the inpainted images. For instance, in some aspects, multiple inpainted images are generated by the generative model 114 and presented to the user. The user could then select one or more of those inpainted images for performing a search. As another example, a single inpainted image could be generated and presented to the user before performing a search to allow the user to provide additional input to modify the inpainted image. For instance, the user could submit text input that is used to generate a prompt that is provided as input (e.g., with the inpainted image) to cause the generative model 114 to generate a new inpainted image based on the additional user input. In further aspects, the one or more inpainted images are not presented to the user prior to performing a search. Instead, the inpainted image(s) are further processed (as described in further detail below) to generate a query and retrieve items as search results without first presenting the inpainted image(s) to the user.

The inpainted image attribute inference component 116 analyzes the inpainted image provided by the generative model 114 to determine one or more inpainted image attributes that can be used to facilitate forming a query by the query component 118, as will be discussed in further detail below. In some aspects, the inpainted image attributes include attributes of the inpainted object. In some aspects, the inpainted image attributes also includes other attributes, such as attributes of other objects in the inpainted image (e.g., object type, appearance, material, etc.).

Similar to the masked image attribute inference component 112, the inpainted image attribute inference component 116 can employ any of a variety of computer vision techniques to analyze the masked image and determine the inpainted image attributes. For instance, the inpainted image attribute inference component 116 can use object detection and classification techniques and appearance inference techniques similar to those discussed above for the masked attribute inference component 112 in order to analyze the inpainted image and determine the inpainted image attributes.

In some aspects, the inpainted attribute inference component 116 leverages the masked image attributes determined by the masked image attribute inference component 112, such as the object types determined for objects in the masked image (including the objects from the underlying input image and/or the mask), visual characteristics of those objects (e.g., color, pattern, material, etc.). The inpainted attribute inference component 116 can also leverage user input, such as text and color selections. In other aspects, the inpainted attribute inference component 116 analyzes the inpainted image independent of the masked image attributes and/or other user input.

The query component 118 generates a query and uses the query to search the item data store 124 to identify items for providing search results. In some instances, the query component 118 generates an image query using the inpainted image to perform a visual search in which item images are identified based on the inpainted image. In some instances, the query component 118 generates a textual query based on masked image attributes, inpainted image attributes, and/or text inputted by the user. In further instances, the query component 118 generates a multi-modal query using the inpainted image and textual information (e.g., masked image attributes, inpainted image attributes, and/or text inputted by the user).

In accordance with some aspects, the query component 118 generates an embedding for performing a search on the item data store 124. The embedding can be generated from the inpainted image, textual information, or a combination thereof. In particular, the query component 118 can employ a machine learning model that takes the inpainted image and/or textual information as input and generates an embedding that is a numerical vector representation in a multi-dimensional vector space.

In some aspects, the query component 118 uses some of the available information (e.g., inpainted image, inpainted image attribute, masked image attributes, additional user input) to generate a query to identify search results and also uses some of the available information to filter and/or rank the search results. For instance, a visual search could be performed using an inpainted image, and the items returned from the visual search could be filtered based on user input (e.g., a textual input provided by the user).

When search results are returned to the user device 102, a user can provide input selecting a particular search result. Based on the user's selection, the composite image component 120 generates a composite image using an image associated with the selected search result. In particular, the composite image component 120 extracts an image of the item associated with the selected search result. This can include retrieving an image for the item and performing background removal to provide an isolated image of the item. The composite image component 120 composites the isolated image of the item on the input image, masked image, or inpainted image to generate the composite image. In some aspects, the isolated image of the item is resized based on the comparative size of the image on which it is being composited.

The search system 104 further includes a user interface component 122 that provides one or more user interfaces for interacting with the search system 104. The user interface component 122 provides one or more user interfaces to a user device, such as the user device 102. In some instances, the user interfaces can be presented on the user device 102 via the application 108, which can be a web browser or a dedicated application for interacting with the content generation system 104. For instance, the user interface component 122 can provide user interfaces for, among other things, interacting with the search system 104 to submit input images and other user input to the search system 104. The user interface component 122 can also provide user interfaces for presenting search results and allowing a user associated with a user device to interact with the search results, for instance, to generate a composite image based on a selected search result.

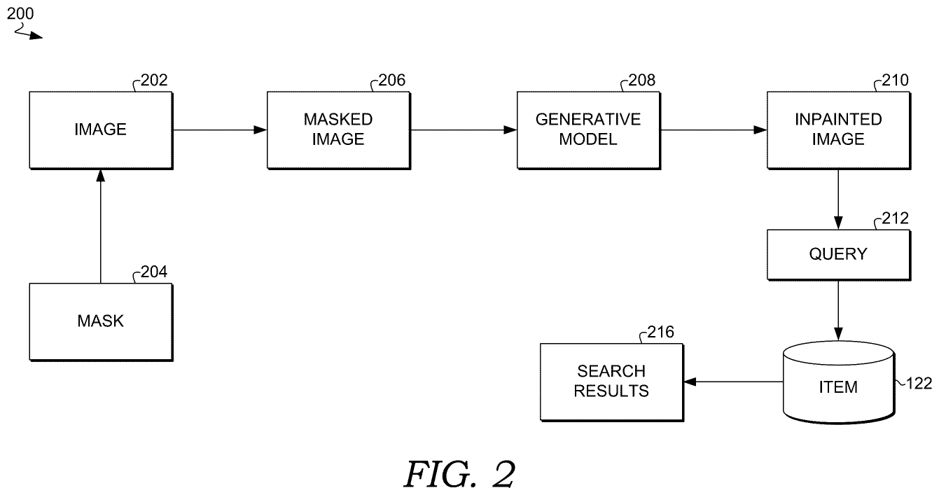

With reference now to FIG. 2, a block diagram is provided that illustrates an example process 200 for using generative inpainting for item retrieval that could be performed, for instance, by the search system 104 of FIG. 1. As shown in FIG. 2, an input image 202 is selected by a user via a user device. The image could be, for instance, one that is captured by a camera on the user device, retrieved from storage on the user device, retrieved from a network location, or an image associated with a search result, recommendation, item page, or other image provided to the user device by the search system. Based on user input, a mask 204 is applied to the input image 202 to generate a masked image 206.

The masked image 206 is provided as input to the generative model 208 (which can correspond to the generative model 114 of FIG. 1). In some aspects, the masked image 206 is provided as the only input; while in other aspects, the masked image 206 is be provided with other inputs. The other inputs could be based on, for instance, text input from the user or masked attribute inferences determined by analyzing the masked image 206. Based on the masked image 206 and any other inputs, the generative model 208 generates an inpainted image 210. While only a single inpainted image 210 is shown in FIG. 2, the generative model 208 can generate multiple inpainted images in some aspects. The generative model 208 generates the inpainted image 210 by determining pixel values for pixels in the mask. In some instances, the generative model 208 can also determine pixel values for pixels outside the mask. By way of example only and not limitation, a delta region can be determined that comprises pixels of an underlying object that is outside of the mask, and the generative model 208 generates new pixel values for pixels in the delta region.

A query 212 is generated using the inpainted image 210 (or multiple inpainted images). The query 212 can be an image query, a textual query, or a combination thereof. The query 212 can be based on the inpainted image alone 210 (e.g., an image query) and/or other information, such as inpainted image attributes, masked image attributes, and user inputs. In some instances, the query 212 comprises an embedding generated from the inpainted image 210 and/or textual information. The query 212 is used to identity items from an item data store 214. Based on the identified items, search results 216 are returned to the user device.

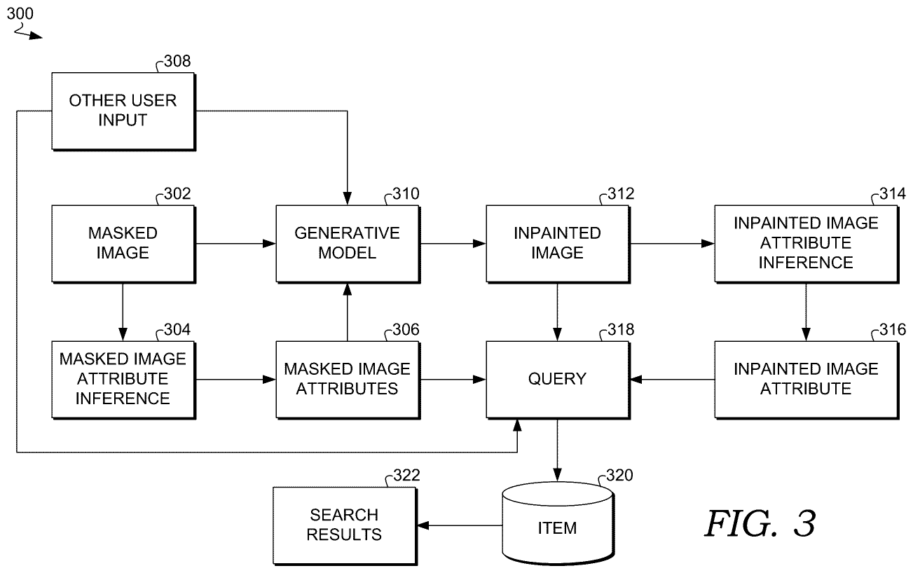

FIG. 3 provides a more detailed block diagram that illustrates another example process 300 for using generative inpainting for item retrieval that could be performed, for instance, by the search system 104 of FIG. 1. As shown in FIG. 3, a masked image 302 is provided for initiating a search. The masked image 302 could be provided by a user employing a user device to select an image and apply a mask to the image. Masked image attribute inference 304 is performed (e.g., by the masked image attribute inference component 112 of FIG. 1) on the masked image 302 to determine masked image attributes 306.

The masked image 302 with the masked image attributes 306 and/or other user input 308 is provided as input to the generative model 310 (which can correspond to the generative model 114 of FIG. 1). The other user input 308 could include, for instance, textual input, color option selections, and other images. Based on the input, the generative model 310 generates an inpainted image 312. While only a single inpainted image 312 is shown in FIG. 3, the generative model 310 can generate multiple inpainted images in some aspects. The generative model 310 generates the inpainted image 312 by determining pixel values for pixels in the mask. In some instances, the generative model 310 can also determine pixel values for pixels outside the mask. By way of example only and not limitation, a delta region can be determined that comprises pixels of an underlying object that is outside of the mask, and the generative model 310 generates new pixel values for pixels in the delta region.

Inpainted image attribute inference 314 is performed (e.g., by the inpainted image attribute inference component 116 of FIG. 1) on the inpainted image 312 to determine inpainted image attributes 316. A query 318 is generated based on the inpainted image 312, the inpainted image attributes 316, the masked image attributes 306, and/or the other user input 308. The query 318 is used to identity items from an item data store 320. Based on the identified items, search results 322 are returned to the user device.

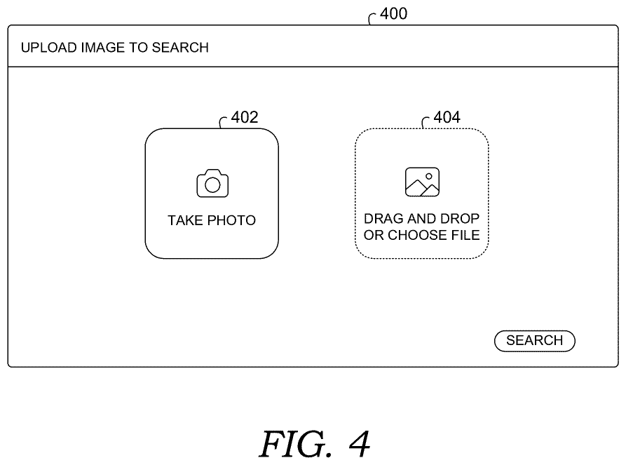

FIGS. 4-6B provide example user interfaces presented on a user device (e.g., the user device 102 of FIG. 1) showing operation of using generative inpainting to facilitate a search in accordance with some aspects of the technology described herein. With initial reference to FIG. 4, an example user interface 400 is shown that allows a user to select an input image for initiating a search. As shown in FIG. 4, the user interface 400 includes two user interface elements for providing an image. The first user interface element 402 provides for taking a photo (e.g., using a camera on the user device) and using the photo as the input image. The second user interface element 404 provides for selecting an existing image as the input image. As previously noted, other ways of selecting an input image could be employed within the scope of the technology described herein.

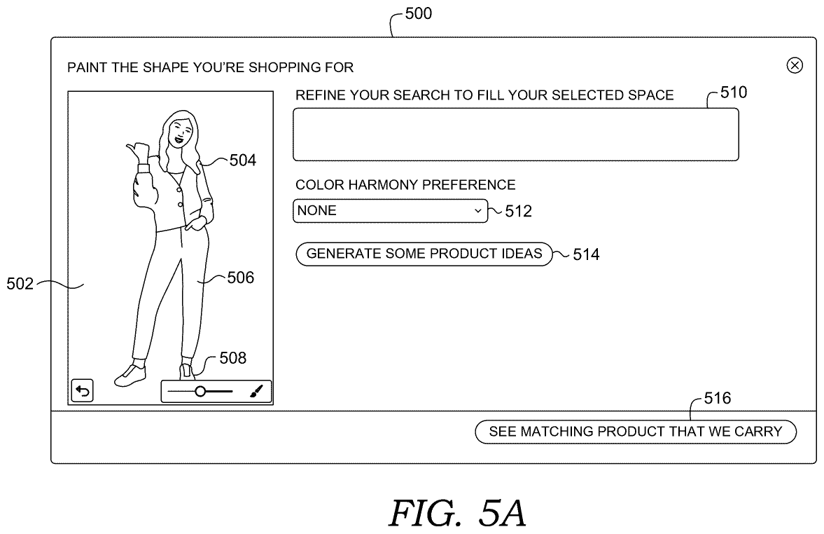

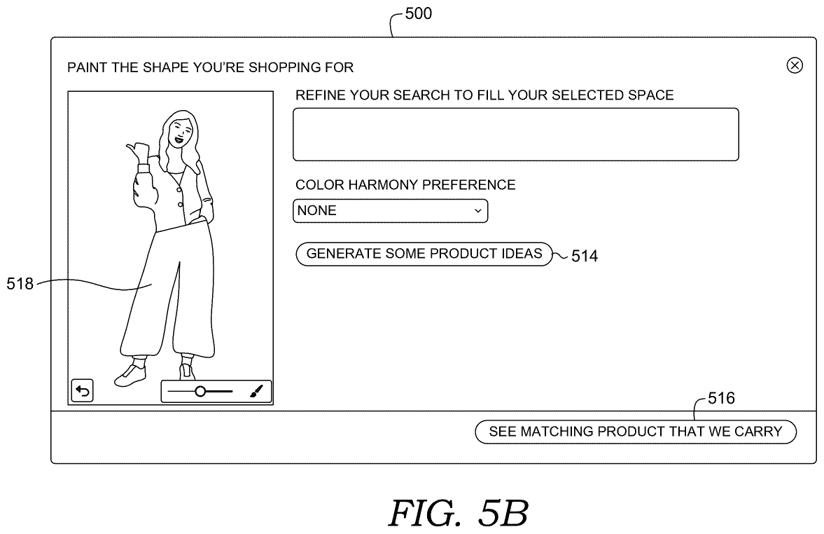

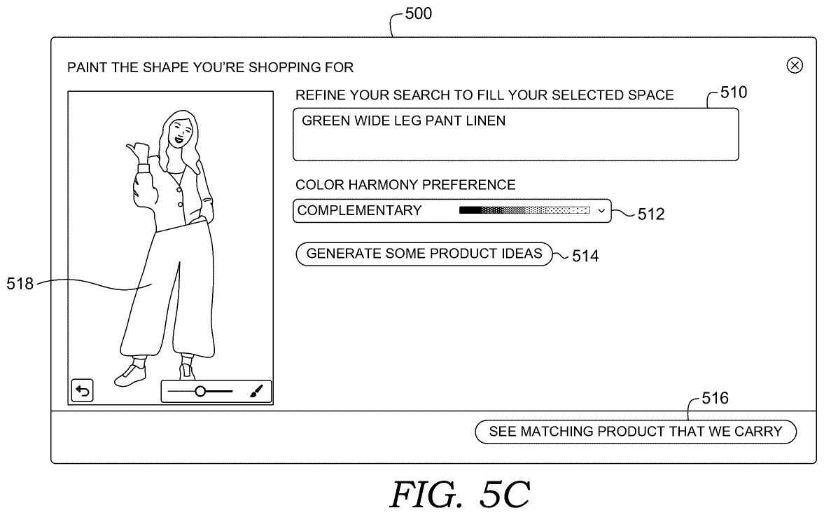

FIGS. 5A-5C show an example user interface 500 for generating a masked image and optionally providing other user inputs for a search. As shown in FIG. 5A, the user interface 500 includes an area presenting an image 502 selected by the user (e.g., using the user interface 400 of FIG. 4). In the present example, the image 502 includes three objects: a shirt 504, pants 506, and a pair of shoes 508. A user employs the user interface 500 to apply a mask to the image 502. As an example to illustrate, FIG. 5B presents the user interface 500 after the user has applied a mask 518 that overlays the pants 506.

The user interface 500 also includes user interface elements for providing additional user input. The additional user interface elements include a text box 510 that allows a user to enter text to refine the search. For instance, in FIG. 5C, the user has entered the text “green wide leg pant linen”. The additional user interface elements also include a user interface element 512 that allows a user to select from a number of color harmony preferences, such as: monochromatic, triad, complimentary, split complementary, compound, and shades color options. For instance, in FIG. 5C, the user has selected a complimentary color preference.

After the user has applied the mask to the image (with or without providing additional user input), the user can select the user interface element 516 to generate product ideas or select the user interface element 518 to perform a search. If the user interface element 516 is selected, a generative model generates one or more inpainted images based on the masked image and any other user inputs and presents the one or more inpainted images to the user on the user device. In some cases, after the inpainted image(s) are presented to the user, the user can provide additional user input to cause the generative model to generate new inpainted image(s) based on the additional user input. For instance, the user could provide text input to modify an aspect of the inpainted image(s). In some aspects, the user can select at least one inpainted image presented to the user for performing a search based on the selected inpainted image(s).

Alternatively, if the user interface element 516 is selected, a generative model generates one or more inpainted images based on the masked image and any other user inputs and performs a search using the inpainted image(s) to identify and return search results to the user device without first presenting the inpainted image(s) to the user on the user device.

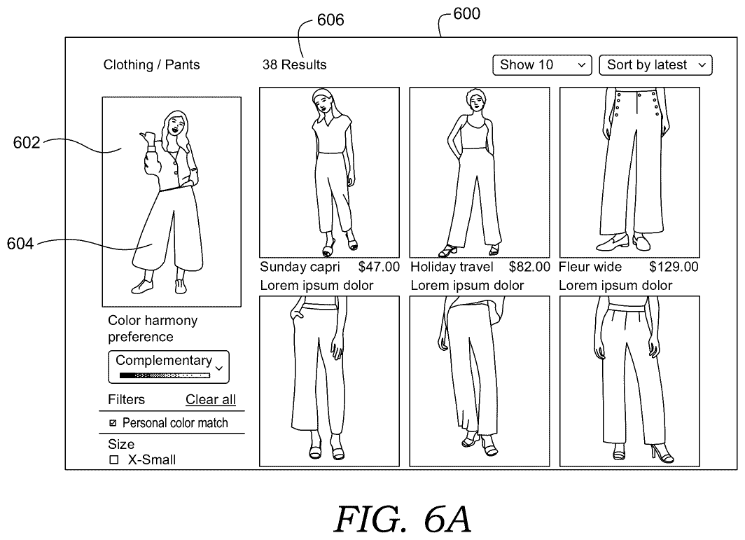

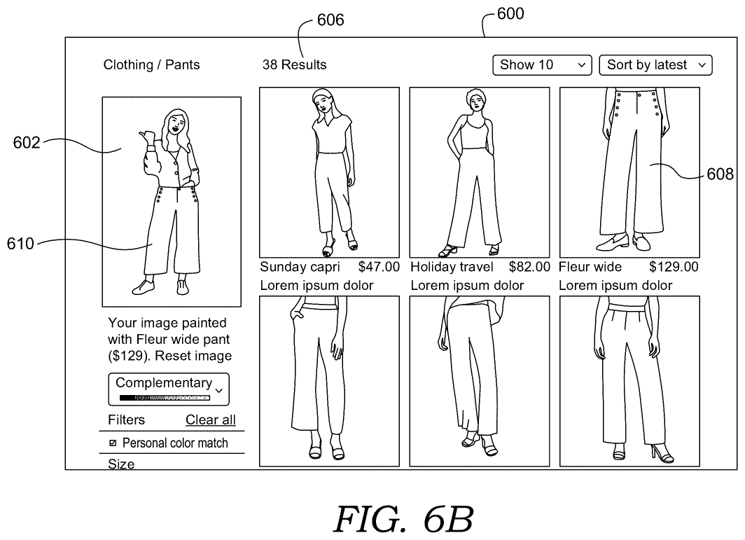

FIGS. 6A and 6B show an example user interface 600 for presenting search results for items identified using the generative inpainting search process described herein. As shown in FIG. 6A, a masked image 602 with a mask 604 is presented on the user interface 600. In other aspects, the input image used to generate the masked image 602 and/or an inpainted image generated using the masked image 602 are displayed in addition to or in lieu of the masked image. Search results 606 for items identified using the inpainted image are also provided on the search results user interface 600. The user can further filter and sort the search results 606.

In some aspects, a composite image can be generated using an image of an item for a user-selected search result. For instance, in FIG. 6B, the user has selected the search result 608. Based on the user selection, background removal is performed on the image associated with the search result 608 to provide an isolated item image. The isolated item image is composited on the masked image (in this example; while in other examples, the isolated item image can be composited on the input image or the inpainted image) to provide a composite image 610 having the isolated item image 612. The isolated item image 612 could be resized to appropriately fit on the composite image 610. Additionally, the isolated item image 612 could be located on the masked image based on a location of the mask in the masked image (or based on the location of the underlying object when compositing on an input image; or based on the location of the inpainted object when compositing on an inpainted image). In this way, a composite image 610 is presented to allow the user to view the selected item in the context of the input image initially selected by the user.

### Example Methods for Item Retrieval Using Generative Inpainting

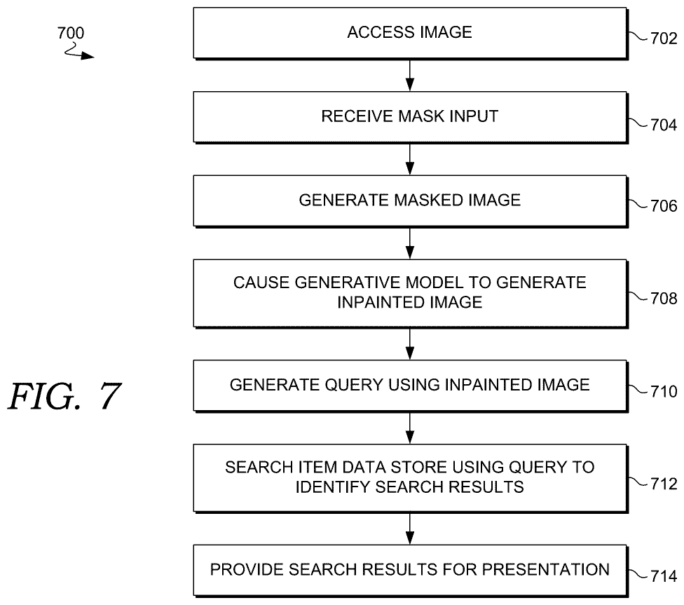

With reference now to FIG. 7, a flow diagram is provided that illustrates an overall method 700 for performing item retrieval using generative inpainting. The method 700 can be performed, for instance, by the search system 104 of FIG. 1. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, an input image is accessed. The input image can be one that is selected by the user using a user device, for instance, by taking a photo, selecting an image stored on the user device or a remote location, or selecting an image associated with a search result, item recommendation, or item page. Mask input is received at block 704. The mask input can comprise user input drawing a mask over the input image. Based on the mask input, a masked image is generated that has a mask overlaying a portion of the input image, as shown at block 706.

A generative model generates an inpainted image using the masked image, as shown at block 708. The input to the generative model can include the masked image alone or the masked image with other inputs, such as, for instance, masked image attributes and other user input (e.g., text input, color selections, other image(s), etc.). The generative model generates the inpainted image by determining pixel values for pixels in the mask. In some instances, the generative model can also determine pixel values for pixels outside the mask, for instance, pixels of a delta region. In some aspects, the generative model generates multiple inpainted images.

As shown at block 710, a query is generated using the inpainted image (or multiple inpainted images) generated by the generative model. The query can be an image query, a textual query, or a combination thereof. The query can be based on the inpainted image alone (e.g., an image query) and/or other information, such as, for instance, inpainted image attributes, masked image attributes, and user inputs. In some instances, the query comprises an embedding generated from the inpainted image and/or textual information.

An item data store is searched using the query to identify items and search results are generated based on those items, as shown at block 712. The search results are provided for presentation on a user device, as shown at block 714. In some configuration, the user can employ the user device to select a search result, and a composite image is generated and provided for presentation on the user device based on an item image associated with the selected search result.

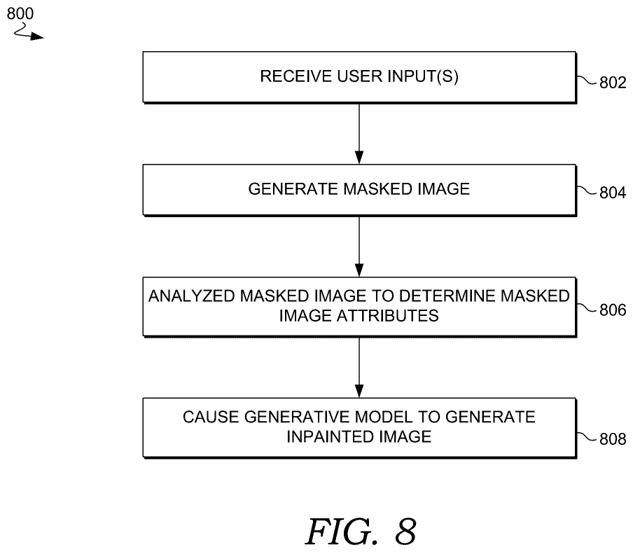

FIG. 8 provides a flow diagram showing a method 800 for generating an inpainted image for item retrieval. As shown at block 802, one or more user inputs are received. The user input includes an input image and input drawing a mask over a portion of the input image. The one or more user inputs can include further user input such as, for instance, text input, color input, and other images.

A masked image is generated based on the input image and the mask, as shown at block 804. The masked image comprises the input image and overlaid mask. The masked image is analyzed at block 806 to determine one or more masked image attributes. The masked image can be analyzed alone or in combination with other information, such as other user input received at block 802. The masked image attributes can include, for instance, information identifying an object type and/or characteristics of objects in the input image/masked image, the mask, and/or the based object on which the mask is overlaid.

Input is provided to a generative model to cause the generative model to generate one or more inpainted image(s), as shown at block 808. The input can include, the masked image generated at block 804 and the masked image attributes determined at block 808. The input can be further based on other user inputs, such as text, color option selections, and/or other objects provided by the user at block 802. The generative model generates the inpainted image(s) by inpainting the mask of the masked image using the input information. This includes determining pixel values for pixels in the mask of the masked image. In some aspects, this also includes determining pixel values for some pixels outside of the mask in the masked image, such as a delta region.

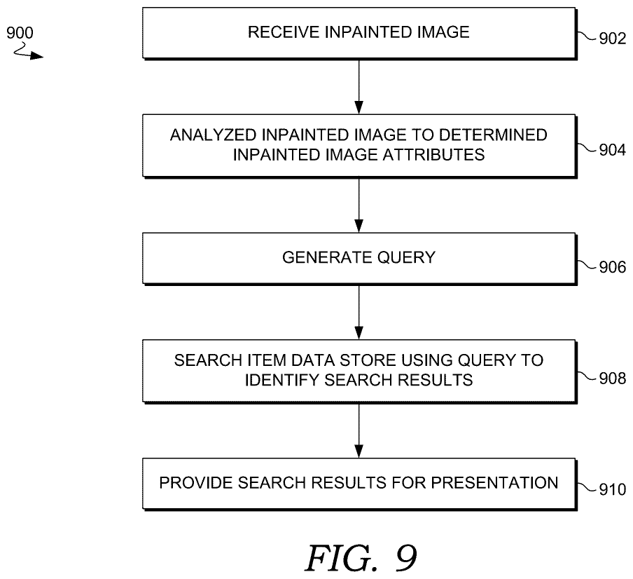

FIG. 9 provides a flow diagram showing a method 900 for generating a query based on an inpainted image and returning search results based on the query. As shown at block 902, an inpainted image is received. The inpainted image is provided by a generative model inpainting a mask of a masked image. In some configurations, multiple inpainted images are received at block 902 and processed in the following steps.

The inpainted image is analyzed to determine inpainted image attributes, as shown at block 904. The inpainted image attributes can be determined based on analysis of the inpainted image alone or in conjunction with other information, such as, for instance, masked image attributes determined for the masked image used as input to the generative model and other user inputs (e.g., text inputs, color option selections, other images, etc.). The inpainted image attributes can include, for instance, object types and/or appearance information (e.g., color, pattern, material, etc.) for the inpainted object, the mask in the masked image, and other objects from the input image.

As shown at block 906, a query is generated. In some aspects, the query is generated using the inpainted image (e.g., an image query), the inpainted image attributes (e.g., a text query), other user inputs (e.g., text), or a combination thereof. In some configurations, the query is a multi-modal embedding generated using the inpainted image and textual information (e.g., the inpainted image attributes). An item data store is searched using the query to identify items to return as search results, at shown at block 908. The search results are provided for presentation on the user device, as shown at block 910.

### Exemplary Operating Environment

Having described implementations of the present disclosure, an exemplary operating environment in which embodiments of the present technology can be implemented is described below in order to provide a general context for various aspects of the present disclosure. Referring initially to FIG. 10 in particular, an exemplary operating environment for implementing embodiments of the present technology is shown and designated generally as computing device 1000. Computing device 1000 is but one example of a suitable computing environment and is not intended to suggest any limitation as to the scope of use or functionality of the technology. Neither should the computing device 1000 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what can be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 10 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory can be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which can be built in. Illustrative components include a microphone, joystick, game pad, satellite dish, scanner, printer, wireless device, etc. The I/O components 1020 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 1000. The computing device 1000 can be equipped with depth cameras, such as, stereoscopic camera systems, infrared camera systems, RGB camera systems, and combinations of these for gesture detection and recognition. Additionally, the computing device 1000 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing an image having one or more objects;
responsive to user input, applying a mask to the image to provide a masked image, the mask overlaying at least a portion of a first object from the one or more objects;
causing a generative model to generate an inpainted image by inpainting the mask of the masked image;
identifying one or more search results using the inpainted image; and
providing the one or more search results for presentation.

2. The one or more computer storage media of claim 1, wherein the operations further comprise:
receiving one or more other user inputs; and
wherein causing the generative model to generate the inpainted image comprises providing input to the generative model based on the one or more user inputs.

3. The one or more computer storage media of claim 2, wherein receiving the one or more other user inputs comprising receiving a text input; and wherein causing the generative model to generate the inpainted image comprises:
generating a prompt based on the text input; and
providing the prompt to the generative model.

4. The one or more computer storage media of claim 1, wherein the operations further comprise:
analyzing the masked image to determine one or more masked image attributes; and
wherein causing the generative model to generate the inpainted image comprises providing at least a portion of the one or more masked image attributes as input to the generative model.

5. The one or more computer storage media of claim 4, wherein the one or more masked image attributes comprise one or more selected from the following: an object type determined based on a silhouette of the mask; an object type of the first object; an appearance of the first object; an object type of one or more other objects in the masked image; and an appearance of the one or more other objects in the masked image.

6. The one or more computer storage media of claim 1, wherein identifying the one or more search results using the inpainted image comprises:
performing a visual search on an item data store using the inpainted image.

7. The one or more computer storage media of claim 1, wherein identifying the one or more search results using the inpainted image comprises:
analyzing the inpainted image to determine one or more inpainted image attributes; and
searching an item data store using the one or more inpainted image attributes.

8. The one or more computer storage media of claim 7, wherein identifying the one or more search results using the inpainted image further comprises:
generating an embedding using the one or more inpainted image attributes; and
wherein the item data store is searched using the embedding.

9. The one or more computer storage media of claim 8, wherein the embedding comprises an multimodal embedding based on the one or more inpainted image attributes and the inpainted image.

10. The one or more computer storage media of claim 1, wherein the operations further comprise:
receiving a selection of a first search result from the one or more search results;
generating a composite image by overlaying an object image corresponding to the first search result one of the image, the masked image, and the inpainted image; and
providing the composite image for presentation.

11. A computer-implemented method comprising:
generating, by a masking component, a masked image from an input image and a mask overlaid on the input image;
analyzing, by a masked image attribute inference component, the masked image to determine one or more masked image attributes;
causing a generative model to generate an inpainted image using the masked image and the masked image attributes;
analyzing, by an inpainted image attribute inference component, the inpainted image to determine or more inpainted image attributes;
generating, by a query component, a query using the inpainted image attributes;
querying, by the query component, an item data store using the query to identify one or more search results; and
providing, by a user interface component, the one or more search results for presentation.

12. The computer-implemented method of claim 11, wherein the masked image is analyzed to determine an object type for one or more objects in the input image.

13. The computer-implemented method of claim 12, wherein the masked image is analyzed to determine at least one appearance attribute for at least one of the one or more objects in the input image.

14. The computer-implemented method of claim 11, wherein the masked image is analyzed to determine an object type for the mask based on a silhouette of the mask.

15. The computer-implemented method of claim 11, wherein the method further comprises receiving text from a user and providing input to the generative model to generate the inpainted image based on the text.

16. The computer-implemented method of claim 11, wherein the inpainted image is analyzed to determine an object type and an appearance attribute for an inpainted object of the inpainted image.

17. The computer-implemented method of claim 11, wherein the query is further generated using the inpainted image.

18. A computer system comprising:
a processor; and
a computer storage medium storing computer-useable instructions that, when used by the processor, causes the computer system to perform operations comprising:
providing, by a masking component, a masked image from an input image and a mask overlaying a portion of the input image;
generating, using a generative model, an inpainted image by determining pixel values of pixels of the mask in the masked image;
generating, by a query component, a query based on the inpainted image;
determining, by the query component, one or more search results using the query; and
providing, by a user interface component, the one or more search results for presentation on a user device.

19. The computer system of claim 18, wherein the operations further comprise determining one or more masked image attributes from analysis of the masked image; and wherein the one or more masked image attributes are provided as input to the generative model to generated the inpainted image.

20. The computer system of claim 18, wherein the operations further comprise determining one or more inpainted image attributes from analysis of the inpainted image; and wherein the query is generated using the one or more inpainted image attributes.
